(19) United States
(12) Patent Application Publication
(10) Pub. No.: US 2003/0131137 A1
(43) Pub. Date: Jul. 10, 2003

(54) Method and apparatus for utilizing a management port to provide system management

(76) Inventors: Doron Chosnek, Houston, TX (US); Richmond LaRue Armstrong, Spring, TX (US); Don A. Dykes, Houston, TX (US); E. David Neufeld, Magnolia, TX (US)

Correspondence Address: Michael G. Fletcher, Fletcher, Yoder & Van Someren, P.O. Box 692289, Houston, TX, 77269-2289, US

(21) Appl. No.: 10/037,508

(22) Filed: Jan. 4, 2002

(51) Int. Cl. G06F 15/16

(52) U.S. Cl. 709/250

(57) ABSTRACT

A computing device includes a network connector located on its front panel. The location of the network connector allows a user, such as a system administrator, to connect a management console to the front of the computing device to facilitate management operations.

### BACKGROUND OF THE INVENTION

1. Field of the Invention

The present invention relates generally to computing devices and, more particularly, to utilization of a management port on a computing device, such as a server, to provide system management capabilities.

2. Description of Related Art

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Digital computers have been helping people solve problems and perform tasks since the 1940s. These early computers, which used vacuum tubes, were quite rare and typically performed just a few specialized tasks. In the early 1960s, transistors began replacing vacuum tubes, thus allowing computers to perform more tasks in less time. This second generation of computers also exhibited a substantial decrease in size as compared with the first generation of computers, and they also proved much more dependable than the earlier machines. By the late 1960s, integrated circuit technology began to emerge, which again greatly increased computer performance and dependability, while further reducing their size.

By the 1970s, computers had become more common and affordable, and general purpose computers, in particular, became increasingly available. Unlike special purpose computers which were designed to perform a very limited number of tasks, general purpose computers could be programmed to perform many kinds of jobs, thus making them popular in a wide variety of businesses. Of course, even these early general purpose computers were still quite large by today's standards and typically permitted only one user. However, as these computers evolved, mainframe computers were developed which had the computing power to host multiple users. In computer networks of this kind, the mainframe computer stored and executed all programs and performed all computations based on input provided to it via “dumb” terminals utilized by the individual users.

While computer networks of this type found widespread use, they were relatively expensive and inflexible, and they tended to cater to a user group rather than individual users. As computer technology advanced during the late 1970s and early 1980s, particularly in the area of miniaturized electronic circuits and memory devices, a fairly significant amount of computing capability could be placed in a box approximately the size of a standard typewriter, thus giving birth to the personal computer. Personal computers became quite popular not only because of their size and fairly significant computing capabilities, but also because each personal computer could be tailored to perform tasks most helpful to its user. Unfortunately, early personal computers did not interface with existing mainframe networks. Accordingly, personal computer users were unable to access programs and information shared by multiple users on such mainframe networks.

To address this problem, distributed networks began to evolve during the 1980s so that multiple personal computers could be connected in a manner to allow the sharing of programs, information, and other resources amongst multiple users, while still providing individual users the flexibility of their own personal computer. As these distributed networks evolved throughout the 1990s, powerful personal computers, commonly referred to as servers, were developed to perform a variety of shared functions on a distributed network, while the typical users coupled to the network used less powerful personal computers. During the course of the 1990s, servers evolved from single processor computers, having a relatively high clock speed and a single high density disk drive, to multiple processor computers having multiple disk drives and, often, redundant or other fail safe capabilities. In short, servers and the networks associated with them became so complex that only system administrators could directly access and alter the programming or functionality of the servers. In fact, depending upon the size of the network, the number of servers, and the geographical distribution of the various servers in the network, the direct access of a particular server by a system administrator became less common than various techniques for allowing the system administrator to access the various servers remotely. Therefore, “headless” servers, i.e., servers which have no display or user input devices, such as a keyboard or mouse, began to proliferate because such user input/output devices became largely unnecessary in view of the remote access capabilities.

Today, it has become common for large and/or complex networks to include several headless servers, which are often designated to perform relatively specified tasks, such as web access, storage, file sharing, etc. Headless servers and networks of this type are typically densely packed adjacent one another in racks. Although certain fold-up type display and keyboard combinations have been developed to fit within such racks so that a network administrator can directly access one or more of the servers in the rack if the need arises, such display/keyboard devices typically occupy more space in the rack than a server, thus displacing valuable space that one or two servers might otherwise occupy. Furthermore, in larger installations, it is not cost effective to have such a display/keyboard device in every rack. Rather, in such installations a cart having a display, keyboard, and mouse is typically used. The cart is wheeled over to a server to which the network administrator desires to connect, and each component is plugged into the back of the selected server. Therefore, for this solution to be effective, the network administrator needs to have access to the back of each server, and each server needs to have the appropriate connections to permit the display, keyboard, and mouse to be coupled to the server.

To exacerbate this problem further, new systems are scheduled to appear in which the servers mounted into the racks are configured with custom connectors that plug into a prewired back plane or mid-plane. The video cart cannot work with such servers because there are no video, keyboard, or mouse connections on the back plane. Thus, unless each rack is provided with a display/keyboard device that is also plugged into the back plane, the system administrator has little choice but to access such servers remotely.

Although remote access generally works well, certain factors can make remote access less desirable than direct access. First, if a network administrator attempts to access the server from a remote terminal at work, the communications must pass through various connections, switches, and devices. If any one of these fails, the system administrator will be unable to access the server remotely. This situation is potentially even more problematic if the system administrator attempts to access the server from a remote terminal located outside of work, such as at home. In this situation, the system administrator must typically use the Internet, and enter through a firewall, thus introducing additional opportunities for communications to fail. Second, remote access is typically slower than direct access because one or more portions of the remote access path maybe bandwidth-limited and/or speed-limited. Third, with the proliferation of computer hackers than may attempt to infiltrate a system to obtain valuable information or merely to disable it, a variety of security concerns abound. Generally speaking, the closer the person requesting access to a server is to the server, the more likely it is that the person can be reliably identified as a person having the actual authorization to access the server. Therefore, for security reasons, it may be desirable to provide only limited access when the server is accessed remotely, and for full access to be granted only by direct connection with the server in the facility that houses the server.

The present invention may be directed to one or more of the problems set forth above.

### BRIEF DESCRIPTION OF THE DRAWINGS

The foregoing and other advantages of the invention will become apparent upon reading the following detailed description and upon reference to the drawings in which:

FIG. 1 illustrates a block diagram of a server having a management processor and a front and a rear network connection;

FIG. 2 illustrates a front view of a server having a network connection thereon;

FIG. 3 illustrates a rear view of the server illustrated in FIG. 2;

FIG. 4 illustrates a rack of servers and a video cart connected to a front port of one of the servers;

FIG. 5 illustrates a block diagram of one embodiment of a communication path using a front network connector and a rear network connector; and

FIG. 6 illustrates a block diagram of an alternate embodiment depicting connection of a front network connector and a rear network connector.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described with reference to the exemplary embodiments below, a computing device is provided with a network connection on its front panel so that a user can couple a video cart or other suitable equipment to the computing device. If the computing device includes a network connector on its back portion, the addition of the front network connector obviates the need for the network administrator to access the rear network connector. In an example where the computing device includes a management processor, the system administrator can access the management processor via the front network connector to perform system management operations.

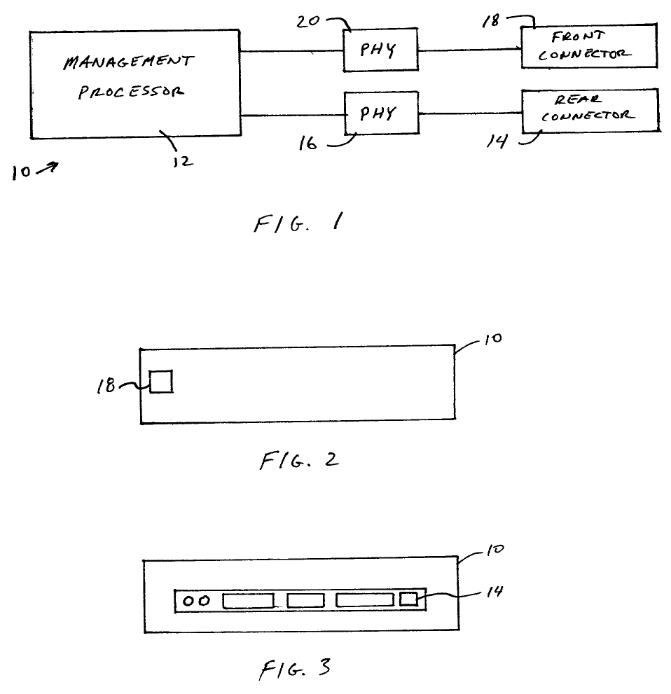

Turning now to the drawings and referring initially to FIG. 1, a computing device 10, such as a server, is illustrated as including a management processor 12. Typical servers having management processors include a network connection, such as an Ethernet connection or a serial connection, that is located on the rear of the server. Similarly, the exemplary server 10 includes a rear network connection 14 that is coupled to the management processor 12 by an appropriate physical layer 16. Unlike a typical device, however, the server 10 also includes a front network connector 18, such as an Ethernet connection or a serial connection, coupled to the management processor 12 by an appropriate physical layer 20.

The physical locations of the front network connector 18 and the rear network connector 14 are illustrated in FIGS. 2 and 3, respectively. As is fairly typical, the rear network connector 14 is one of many connectors found on the rear of a server. The rear network connector 14 is generally connected in a manner that allows remote users to access the server 10. But for the presence of the front network connector 18, a system administrator seeking direct access to the server 10 would probably be required to disconnect users from the network connection 14 and attach a management console having, at least, a display and an input device such as a keyboard and/or a mouse. Of course, as mentioned previously, if the rear network connector 14 is configured to be plugged into a back plane of a rack, a system administrator would not have access to the rear network connector 14.

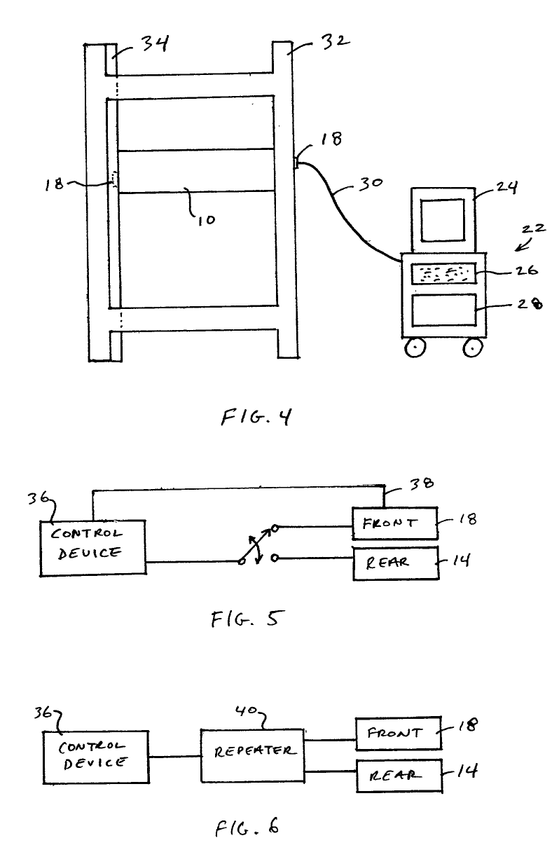

The presence of the front network connector 18 obviates this problem. To access the server 10 directly, a system administrator merely couples a management console 22, which may include a display 24, an input device 26 (such as a keyboard and/or mouse), and/or a processor 28 to the front network connector 18 via an appropriate cable 30, as illustrated in FIG. 4. The system administrator need not move the rack 32 in which the server 10 is mounted, nor reach behind the rack 32, to disconnect the rear network connector 14 from current users. Furthermore, the front network connector provides the system administrator direct access to the server 10 even if the rack 32 includes a back plane 34 that does not permit the system administrator access to the rear network connector 14.

At least two alternative techniques may be used to facilitate communication between the management processor 12 and the front and rear network connectors 18 and 14. As illustrated in FIG. 5, the management processor 12 may contain firmware 36 that effectively switches between the rear network connector 14 and the front network connector 18. Several methods may be used for switching between the two connectors 14 and 18. For example, a network switch, a hub chip, or two network PHYs may be used to provide such switching. The PHY, for example, provides a link status to the firmware, and the firmware simply communicates through the front network connector 18 when the network link is detected through the front network connector 18.

During normal operation, a system administrator does not have a console 22 coupled to the front network connector 18. Accordingly, the firmware selects to receive signals from the rear network connector 14. However, when the system administrator couples a cable 30 to the front network connector 18, the firmware discontinues communications with the rear network connector 14 and switches to receiving communications from the front network connector 18. Although the decision to selection communications from the front network connector 18 may be triggered by any suitable means, the front network connector 18 may be provided with a pin sensor (not shown) so that a signal is delivered to the firmware 36 on the line 38 to indicate that a cable 30 have been coupled to the front network connector 18. In response to this trigger signal from the pin sensor, the firmware 36 switches from the rear network connector 14 to the front network connector 18. The signal from the pin sensor may be maintained as long as the cable 30 is coupled to the front network connector 18, so that decoupling of the cable 30 from the front network connector 18 deasserts the signal from the pin sensor and causes the firmware 36 to switch from the front network connector 18 to the rear network connector 14. The firmware may also switch back to the rear connector 14 after an absence of network activity through the front network connector 18 for some amount of time.

It should be apparent that the technique described with reference to FIG. 5 permits the management processor 12 to communicate only with either the rear network connector 14 or the front network connector 18 at any given time. However, situations may exist where it would be desirable for the management processor 12 to communicate with both the rear network connector 14 and the front network connector 18 at substantially the same time. To accomplish this goal, the rear network connector 14 and the front network connector 18 may be coupled to a network hub chip 40 that, in turn, is coupled to the firmware 36 of the management processor 12. The network hub chip 40 functions much like an external network hub by retransmitting all network traffic to all connected devices. The network hub chip 40 routes signals from both the rear network connector 14 and the front network connector 18 to the firmware 36. The hub chip 40 may be replaced by a network switch chip, which would transmit network traffic only to the intended recipient to facilitate similar simultaneous communication by reducing the number of collisions.

As can be seen from the above discussion, the provision of a front network port 18 on the server 10 provides a number of advantages. For example, it provides easy physical access so that the system administrator does not have to attempt to couple a management console to the rear of the server 10. To simplify matters further, since the server 10 would probably include only one port on its facade, the system administrator need not guess about which port to use. The direct access bypasses network infrastructure which, as described above, could possibly inhibit communication between the network administrator and the server 10. The direct access further provides an extremely secure connection and allows the use of a static IP address, with no need for the DHCP of the server. Furthermore, the front network port can run at a different speed from the rear network port, e.g., a lower speed such as 10 Mbits/sec, so that less complex and expensive console equipment may be used. Also, in unusual cases, the front network port can provide some redundancy in case of a hardware failure of the rear network port so that normal users could be connected to the front network port. Another advantage concerns the ability to provide a light on the front of the server 10 to indicate that it is the one in need of attention, so that an administrator can simply move the cart into position and couple the cable 30 to the front network connector 18 of the lit unit.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A headless server having a front and a back, the server comprising:
a management processor;
a first network connector disposed on the front of the server;
a second network connector disposed on the back of the server; and
a coupling device adapted to couple at least one of the first network connector and the second network connector to the management processor.

2. The server, as set forth in claim 1, wherein the first network connector comprises an Ethernet connector.

3. The server, as set forth in claim 1, wherein the first network connector comprises a serial connector.

4. The server, as set forth in claim 1, wherein the second network connector comprises an Ethernet connector.

5. The server, as set forth in claim 1, wherein the second network connector comprises a serial connector.

6. The server, as set forth in claim 1, wherein the coupling device comprises a switch to adapted to alternately couple the first network connector and the second network connector to the management processor.

7. The server, as set forth in claim 6, wherein the coupling device comprises a control device coupled to the switch to selectively alternate the switch between the first network connector and the second network connector.

8. The server, as set forth in claim 1, wherein the coupling device comprises one of a network hub and a network switch adapted to couple the first network connector and the second network connector to the management processor simultaneously.

9. The server, as set forth in claim 8, wherein the coupling device comprises a control device coupled to the one of the network hub and network switch to control communications from the first network connector and the second network connector.

10. A computer system comprising:
a rack; and
a plurality of servers mounted in the rack, each of the plurality of servers having a front and a back, wherein at least one of the plurality of servers comprises:
a management processor;
a first network connector disposed on the front of the server;
a second network connector disposed on the back of the server; and
a coupling device adapted to couple at least one of the first network connector and the second network connector to the management processor.

11. The system, as set forth in claim 10, wherein the first network connector comprises an Ethernet connector.

12. The system, as set forth in claim 10, wherein the first network connector comprises a serial connector.

13. The system, as set forth in claim 10, wherein the second network connector comprises an Ethernet connector.

14. The system, as set forth in claim 10, wherein the second network connector comprises a serial connector.

15. The system, as set forth in claim 10, wherein the coupling device comprises a switch adapted to alternately couple the first network connector and the second network connector to the management processor.

16. The system, as set forth in claim 15, wherein the coupling device comprises a control device coupled to the switch to selectively alternate the switch between the first network connector and the second network connector.

17. The system, as set forth in claim 10, wherein the coupling device comprises one of a network hub and network switch adapted to couple the first network connector and the second network connector to the management processor simultaneously.

18. The system, as set forth in claim 17, wherein the coupling device comprises a control device coupled to the one of the network hub and network switch to control communications from the first network connector and the second network connector.

19. The system, as set forth in claim 10, wherein the rack comprises a backplane, and wherein the second network connector is coupled to the backplane.

20. A method of administrating a computer comprising the act of:
coupling a management console to a network connector located on a front portion of the computer.
